(19) United States
(12) Patent Application Publication
(10) Pub. No.: US 2003/0160906 A1
(43) Pub. Date: Aug. 28, 2003

(54) Image forming method

(76) Inventor: Mitsutoshi Nakamura, Kawanishi-shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/081,699

(22) Filed: Feb. 22, 2002

(51) Int. Cl. G02F 1/13

(52) U.S. Cl. 349/20

(57) ABSTRACT

Disclosed herein is an image forming method for forming an image on a reversible thermo-sensitive recording medium provided with a recording layer containing liquid crystal that exhibits a solid phase or a fixed phase at a room temperature and a cholesteric liquid crystal phase at higher temperature. Specifically, the image forming method comprises: a first heating process for heating the liquid crystal in a crystal phase to a first temperature that allows the liquid crystal to exhibit the cholesteric liquid crystal phase or an isotropic phase to form an image and for rapidly cooling the liquid crystal to fix thus formed image; and a second heating process for heating at least a part of an area of the recording medium containing at least a part of an area where the image has been formed to allow at least a part of the image to discolor or develop a color and for rapidly cooling the liquid crystal to fix thus discolored or developed image.

### CROSS-REFERENCE TO RELATED APPLICATION

This application is based on Japanese Patent Application No. 2001-029678 filed in Japan on Feb. 6, 2001, the entire content of which is hereby incorporated by reference.

### BACKGROUND OF THE INVENTION

1. Field of the Invention

The present invention relates to an image forming method, and more particularly to an image forming method for forming an image on a reversible thermo-sensitive recording medium by using a liquid crystal that exhibits a cholesteric phase.

2. Description of the Related Art

In recent years, from the viewpoint of energy saving and environmental conservation, recording media capable of rewriting information have been received much attention as a medium substituting a paper medium. However, rewritable recording media which have been put into practical use at present are used as black and white display or mono-color display, and there have been strong demands for recording medium capable of full color display.

With respect to a recording material capable of rewritable, as well as of displaying with full-color, a high-molecular cholesteric liquid crystal has been known; however, this has a slow response speed at the time of recording, and has not been put into practical use. A low-molecular/medium-molecular cholesteric liquid crystal has been proposed as a recording material that can solve this problem.

This material is allowed to develop a color, only after this material is once heated to an isotropic phase, and then cooled down to a cholesteric liquid crystal phase having a desired selective reflection property, and further cooled down rapidly from this temperature. For this reason, in order to develop a desired color, a complex temperature control is required for each dot of pixels. Moreover,with respect to a color development on the low temperature side, it takes a long time to provide a predetermined temperature, and this causes a problem as degradation in the resolution since the thermal conduction is exerted laterally.

### SUMMARY OF THE INVENTION

In order to solve the above-mentioned problems, it is an object of the present invention to provide an image forming method which can provide a desired color development by an easy temperature controlling operation, thereby achieving rewritable, full-color display.

In order to achieve this object, the image forming method in accordance with the present invention, which relates to an image forming method for forming an image on a reversible thermo-sensitive recording medium provided with a recording layer containing liquid crystal that exhibits a cholesteric liquid crystal phase, is provided with a first heating process for heating the liquid crystal in a crystal phase status to a temperature that allows it to exhibit a cholesteric liquid crystal phase or an isotropic phase to form an image, and with a second heating process for heating one portion of or all of the areas of the recording medium containing at least one portion of the area where the image has been formed to allow at least one portion of the image to discolor or develop a color.

The image forming method in accordance with the present invention relates to a reversible thermo-sensitive recording medium provided with a recording layer containing a liquid crystal that exhibits a cholesteric liquid crystal phase, and is provided with a first heating process for heating a liquid crystal in a crystal phase to form an image (visible image or latent image) and with a second heating process for discoloring (with respect to the visible image) or color-developing (with respect to the latent image) the image thus formed.

In the image forming method in accordance with the present invention, in the first heating process, the liquid crystal in a crystal phase is heated to a temperature that allows it to exhibit a cholesteric liquid crystal phase or an isotropic phase, and then rapidly cooled down on demands. Here, the liquid crystal corresponding to the image (heated portion) is turned into a glass phase. In the second heating process, the liquid crystal is allowed to transit from the glass phase to a liquid crystal phase. This transition temperature is comparatively low, and even when a wide area containing an area in which an image has been formed in the first heating process is heated, only the image portion is allowed to develop a color or to be discolored. Therefore, it is easy to control the temperature in each of the heating processes. Moreover, the image formation may be carried out by two heating processes in a divided manner so that in the first heating process, images with a high resolution are formed, and in the second heating process, these are discolored or allowed to develop a color; thus, it is possible to prevent degradation in the resolution in the low-temperature side color development.

Moreover, in the image forming method in accordance with the present invention, a third heating process may be provided in which the liquid crystal is heated to be set to a cholesteric liquid crystal phase. Even in the case of a recording medium in which an image has already been formed, by subjecting the recording medium to this third heating process, the liquid crystal is set to the initial state, thereby making it possible to write a new image.

Furthermore, in the image forming method in accordance with the present invention, the second heating process can be carried out anytime as long as it is conducted after the completion of the first heating process. Therefore, for example, a reversible thermo-sensitive recording medium that has been subjected to only the first heating process may be stored, transported or utilized, and after a lapse of time, this reversible recording medium may be subjected to the second heating process. Moreover, in another example, the first heating process is successively carried out on a plurality of reversible thermo-sensitive recording media, while the second heating process may be carried out simultaneously.

### BRIEF DESCRIPTION OF DRAWINGS

These and other objects, advantages and features of the invention will become apparent from the following description thereof taken in conjunction with the accompanying drawings in which:

FIG. 1 is a cross-sectional view that shows one example of a reversible thermo-sensitive recording medium to which an image forming method in accordance with the present invention is applied;

FIG. 2 is a graph that shows the relationship between the reaction heat and the heating temperature at which a liquid crystal is allowed to transit from a crystal phase;

FIG. 3 is a graph that shows the relationship between the reaction heat and the heating temperature at which a liquid crystal is allowed to transit from a fixed phase;

FIG. 4 is a graph that shows the relationship between the heating temperature and a color development of a liquid crystal;

FIG. 5 (A) is a flow chart that shows the process of image forming method 1;

FIG. 5 (B) is an explanatory drawing that shows a display state of a recording layer in image forming method 1;

FIG. 6 (A) is a flow chart that shows the process of image forming method 2;

FIG. 6 (B) is an explanatory drawing that shows a display state of a recording layer in image forming method 2;

FIG. 7 is an explanatory drawing that shows image forming processes;

FIG. 8 is a perspective view that shows one example of a hot stamp used in an image formation; and

FIG. 9 is a perspective view that shows another example of a hot stamp used in the image formation.

### DESCRIPTION OF THE PREFERRED EMBODIMENTS

Referring to attached drawings, an explanation will be given to preferred embodiments of an image forming method in accordance with the present invention.

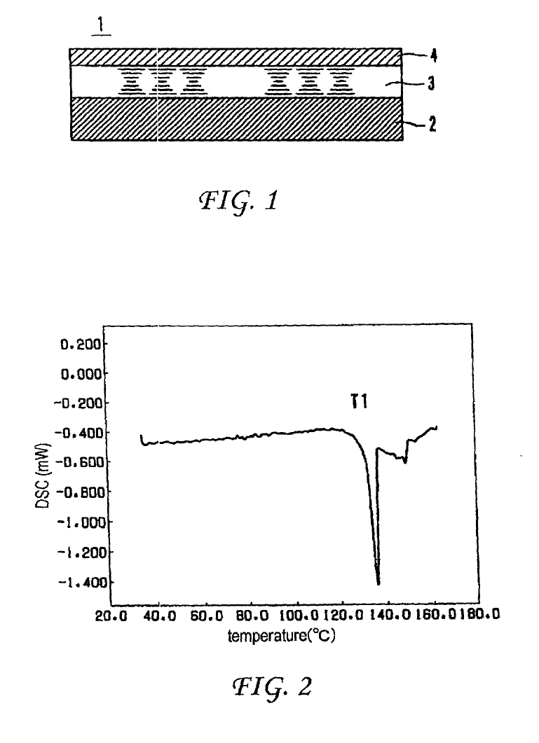

(Construction of a Reversible Thermo-Sensitive Recording Medium, See FIG. 1)

First, referring to FIG. 1, an explanation will be given of one structural example of a reversible thermo-sensitive recording medium to which an image forming method in accordance with the present invention is applied. However, the recording medium to which the present invention is applied is not limited to the medium shown in FIG. 1; and various types of recording media can be applied.

reversible thermo-sensitive recording medium 1 is constituted by a support base 2 on which a recording layer 3 containing a cholesteric liquid crystal composition is formed, and a protective layer 4 is stacked thereon, if necessary. The recording layer 3 contains a liquid crystal that exhibits a cholesteric liquid crystal phase. With respect to applicable liquid crystalline compounds, an explanation will be given of them later.

With respect to the support base 2, various materials, such as glass, plastic, metal and paper, may be used, as long as it can maintain a mechanical strength serving as a recording medium 1, and a thermo-plastic temperature not less than the melting point of a material constituting the recording layer 3. When a light-absorbing layer is placed on the surface or rear surface of the support base 2, it is possible to provide a black color display on the recording layer 3 that is in a transparent state by absorbing transparent light. The support base 2 itself may have a light-absorbing effect.

The protective layer 4 protects the surface of the recording layer 3 physically as well as chemically, and is placed on demands. With respect to the protective layer 4, materials which are superior in light-transmitting property with high heat resistance are preferably used, and the same material as the support base 2 may be used.

Moreover, in order to allow the recording layer 3 to have a constant thickness, spacers and resin structural members may be placed thereon with an appropriate distribution. Moreover, an alignment control film may be formed on a surface at which the support base 2 and the protective layer 4 come into contact with the recording layer 3.

(Liquid Crystalline Composition)

With respect to the recording medium 1, various types of liquid crystalline compounds may be used as long as they exhibit a cholesteric liquid crystal phase when heated. General formulas (A) to (E) of typically applicable compounds are shown below:

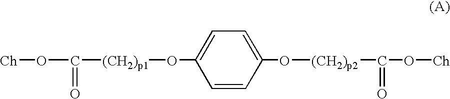

wherein p1, p2 are respectively integers of 5 to 12,

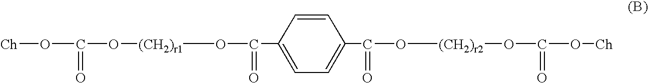

wherein r1, r2 are respectively integers of 3 to 10,

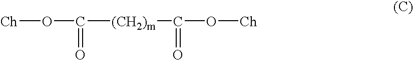

wherein m is an integer of 6 to 20,

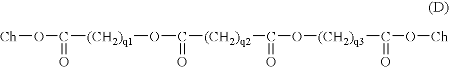

wherein q1, q2 and q3 are respectively integers of 3 to 10,

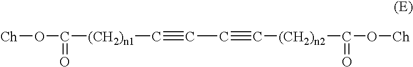

wherein n1,n2 are respectively integers of 5 to 12.

In (A) to (E), Ch is represented by:

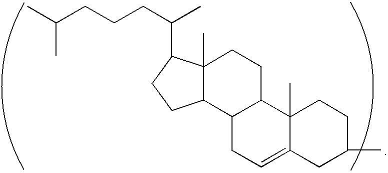

However, applicable compounds are not limited to those represented by the above-mentioned general formulas. These compounds may be solely used, or two or more kinds of these may be used in a mixed manner. In the case when two or more kinds of these are mixed, depending on the kinds and mixed ratios of the combination, factors as to whether or not a cholesteric liquid crystal phase is exerted by applying heat and as to how much time the cholesteric liquid crystal phase is maintained greatly differ; therefore, the kinds and mixed ratios need to be set by taking into consideration application states, etc. of the recording medium. Moreover, the compounds of this type may be used as a composition dispersed in an appropriate transparent resin binder, such as polycarbonate, PMMA, polyvinyl alcohol and polyamide.

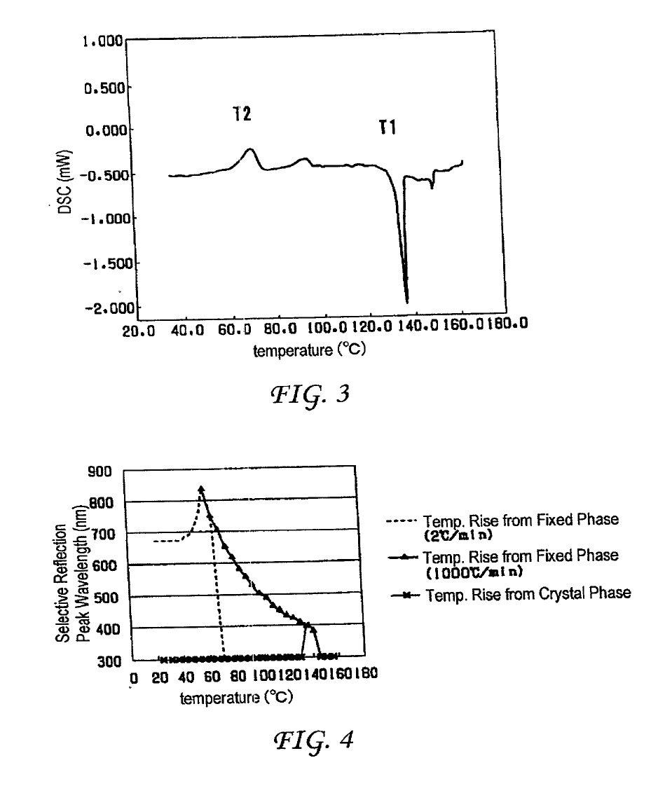

(Principle of the Image Forming Method, See FIGS. 2 to 4)

In the preferred embodiments described below, the fact that the temperature at which a liquid crystal transits from a crystal phase to cholesteric liquid crystal phase or to an isotropic phase is different from the temperature at which a cholesteric fixed phase (which refers to a fixed phase obtained by abruptly cooling down the cholesteric liquid crystal phase, and also refers to as a glass phase) is allowed to transit to the cholesteric liquid crystal phase is utilized.

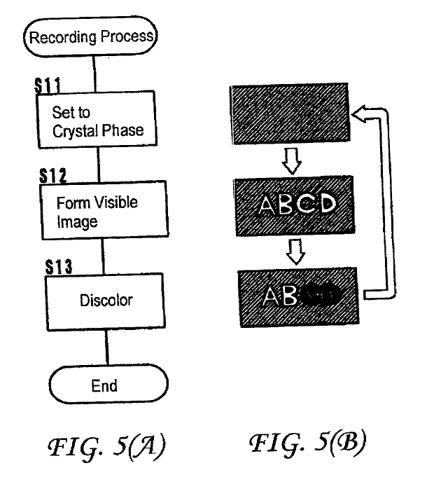

FIGS. 2 and 3 show data obtained by measuring the reaction heat with a differential scanning calorimeter (DSC) at the time when a liquid crystal is heated at a temperature rise rate of 2° C./min. FIG. 2 shows the transition from a liquid crystal phase in which no change is exerted up to temperature T1. FIG. 3 shows the transition from a fixed phase in which a peak of heat generation is seen at temperature T2, and the transition to a crystal phase is observed. Here, in the liquid crystal used in this case, by abruptly heating up to temperature T2 (for example, at a temperature rise rate of 1000° C./min), it is allowed to transit to a cholesteric liquid phase prior to the transition to the crystal phase. Moreover, FIG. 4 shows a state in which the developed color changes (a peak wavelength of selected reflection with respect to the heating temperature).

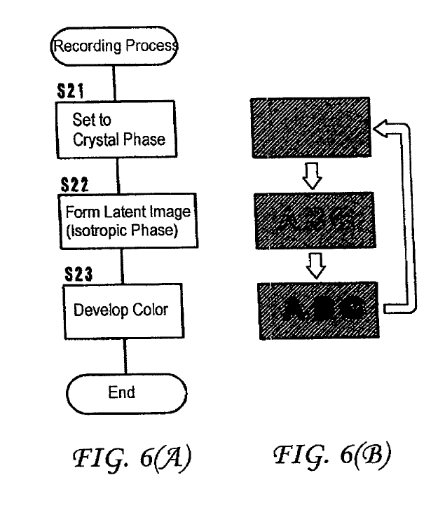

(Image Forming Method, See FIGS. 5, 6)

Next, an explanation will be given of an image forming method on the above-mentioned reversible thermo-sensitive recording medium. This image forming method is mainly classified into method 1 shown in FIGS. 5 (A) and 5 (B) and method 2 shown in FIG. 6.

In image forming method 1 (see FIG. 5 (A)), the liquid crystal is set to a crystal phase at step S11. The heating process in this step is carried out at a comparatively low temperature, and the heating process is continuously carried out for not less than a predetermined time or after the heating process, a cooling step is carried out for not less than a predetermined time. Here, in the case when the reversible thermo-sensitive recording medium has been preliminarily set to the crystal phase, this step S11 can be omitted.

Next, at step S12, the liquid crystal maintained in the crystal phase is heated to a temperature at which it is allowed to exhibit a cholesteric liquid crystal phase to form an image. Here, the image formed in this case is a colored visible image. The heating temperature used in this step is temperature T1 shown in FIG. 2, and after the transition to the liquid crystal phase, this is quickly cooled down to fix the image (the liquid crystal is allowed to transit to a fixed phase).

Next, at step S13, all the area or one portion of the area at which the visible image has been formed is heated to discolor the entire portion or one portion of the visible image. In FIG. 5 (B), a visible image of “ABCD” is formed at step S12, and “CD” is discolored at step S13. In this step, the heating process is abruptly carried out, and the heating temperature is set to the temperature T2 to T1 shown in FIG. 3, and differently set depending on a color to be displayed. Moreover, after the transition to the liquid crystal phase, this is quickly cooled down so as to fix the image (where the liquid crystal is allowed to transit to a fixed phase).

In image forming method 2 (see FIG. 6 (A)), in the same manner as the above-mentioned step S11, a liquid crystal is set to a crystal phase at step S21. Here, in the case when the reversible photosensitive recording medium is set to the crystal phase, the step S21 is omitted.

Next, at step S22, the liquid crystal in the crystal phase is heated to a temperature at which it is allowed to exhibit an isotropic phase to form an image. The image formed here is a latent image. In this process, the heating temperature is a temperature slightly higher than temperature T1 shown in FIG. 2, and after the transition to the isotropic phase, this is quickly cooled down to fix the image (the liquid crystal is allowed to transit to a fixed phase).

Next, at step S23, the area at which the latent image has been formed is heated to develop the latent image. FIG. 6 (B) shows an example in which a latent image of “ABC” is formed at step S22, and “ABC” is allowed to develop a color at step S23. In this step, the heating process is carried out abruptly, and the heating temperature is set to T2 to T1 shown in FIG. 3, and is different depending on colors to be displayed. Moreover, after the transition to the liquid crystal phase, this is quickly cooled down to fix the image (the liquid crystal is allowed to transit to a fix phase).

Here, in image forming methods 1, 2, even after images have been written at the above-mentioned steps S13, S23, by setting the liquid crystal again to the liquid crystal phase, it is possible to write a new image.

Moreover, in both of image forming methods 1 and 2, steps S13 and S23 may be carried out immediately after the completion of the steps S12 and S22, or after a lapse of a desired time therefrom. Therefore, for example, after having been subjected to steps S12 and S22, the reversible thermo-sensitive recording medium may be stored, transported or utilized, and after a lapse of a predetermined time, the processes of steps S13, S23 can be carried out on the reversible thermo-sensitive recording medium. Here, in another example, the first heating process is successively carried out on a plurality of reversible thermo-sensitive recording media, while the second heating process can be simultaneously carried out thereon. In this manner, image forming methods 1 and 2 can be applied to various application fields, and have many potentials.

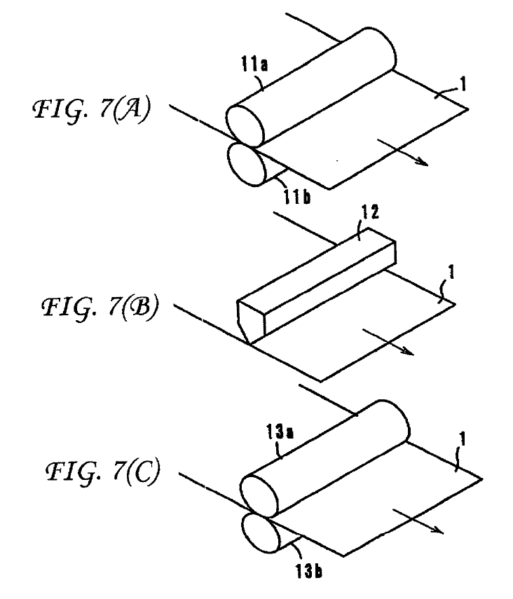

(Heating Means, See FIGS. 7 to 9)

With respect to heating means used in the above-mentioned three heating processes, various heating means, such as a hot plate, a thermal head, a hot stamp (stage), a laser and a hot roller, are listed. For example, as shown in FIG. 7, a recording medium 1 is allowed to pass through hot rollers 11a and 11b so as to be set to a crystal phase (steps S11, 21), and by allowing this to pass right below a thermal head 12 so as to form a visible image or a latent image (steps S12, 22), and then by allowing this to pass through hot rollers 13a, 13b so as to be discolored or allowed to develop a color (steps S13, 23).

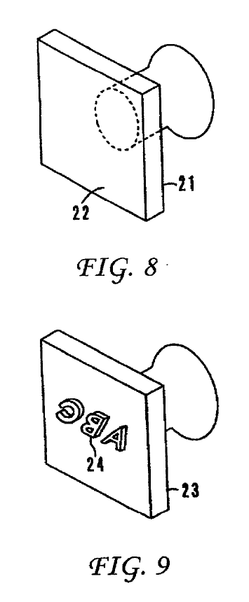

The heating means for the image formation and the heating means for discoloration or color development may be provided as the same heating device. For example, in the case when a thermal head is commonly used, the energy control is carried out on a pixel basis in the image formation, while the entire pixels are controlled by the same energy at the time of discoloration or color development. In the case when a hot stamp is commonly used, as shown in FIG. 8, at the time of transition to a crystal phase, and at the time of discoloration or color development, a hot stamp 21 having a heating face 22 with a flat, wide area is used. Moreover, in the case when an image is formed, as illustrated in FIG. 9, a hot stamp 23 having a heating face in which a character 24 is engraved is used.

At the time of discoloration or color development, the heating means can heat a large area including an image; therefore, a heating means having a larger area for a simuiltaneous heating operation than the heating means at the time of image formation can be used. As described above, the processes of discoloration and color development can be simultaneously carried out on a plurality of reversible thermo-sensitive recording media so that a heating furnace and an oven having chambers capable of accommodating a plurality of recording media may be used as a heating means.

Here, with respect to the cooling means, various means such as a cold stamp, a cold roller, cold air, cold water and a Peltier element, are listed.

### EXAMPLE 1

A black polyethylene terephthalate film (hereinafter, referred to as PET film) having a thickness of 188 μm was used as a support base, and a material formed by mixing the compounds represented by the following chemical formulas (A1) and (B1) at a weight ratio of 1:1 was heated to melt at 170° C., and applied thereto with a thickness of 6 μm to form a recording layer. Further, the recording layer was coated with a transparent PET film having a thickness of 6 μm to form a thermo-sensitive recording medium.

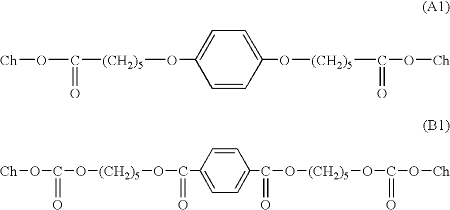

In both of (A1) and (B1), Ch is represented by:

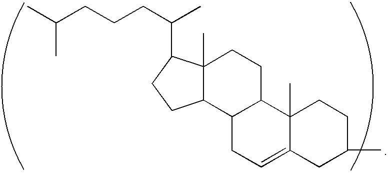

The entire recording medium was heated at 80° C. for 15 minutes to obtain a black background. Next, after the entire recording medium had been cooled down to room temperature, a hot stamp bearing an engraved character that had been heated to 140° C. was pressed thereon, and this was then cooled down to record a blue-colored character on the black background. Next, after having pressed a heated hot roller of 100° C. to the half of the area of the recording medium, this was quickly cooled down so that only the character was changed in color from blue to green; thus, characters of two colors of blue and green were formed on the black background. Moreover, the entire recording medium was again heated at 80° C. for 15 minutes to erase the characters.

### EXAMPLE 2

A thermo-sensitive recording medium was manufactured in the same manner as the above-mentioned example 1, and heated in the same manner to obtain a black background. Next, after a hot stamp bearing a character engraved therein heated to 170° C. had been pressed thereon, this was quickly cooled down; however, no character was confirmed on the black background (since this was formed as a latent image) . Next, after a hot roller heated to 80° C. had been pressed on the entire recording medium, this was quickly cooled down so that a red character appeared.

### Example 3

A thermo-sensitive recording medium was manufactured in the same manner as the above-mentioned example 1, and heated in the same manner to obtain a black background. Next, a printing process was carried out on the recording medium by using a reader writer SD500-GPIII made by San Denshi Kogyo K.K. so that a blue character was recorded. Next, after a hot roller heated to 80° C. had been pressed on half the area of the recording medium, this was quickly cooled down; thus, the character was discolored to red so that the character of two colors, blue and red, was formed on the black background.

### EXAMPLE 4

A thermo-sensitive recording medium was manufactured in the same manner as the above-mentioned example 1, and a blue character was recorded on the black background in the same manner as example 3. Next, after the recording medium had been placed on a hot plate having a temperature gradient, this was quickly cooled down so that a character having red, green and blue colors with a gradation was recorded on the black background.

### EXAMPLE 5

A black PET film having a thickness of 188 μm was used as a support base, and a material formed by mixing the compounds represented by the following chemical formulas (A1) and (B1) at a weight ratio of 1:2 was heated to melt at 170° C., and applied thereto with a thickness of 6 μm to form a recording layer. Further, the recording layer was coated with a transparent PET film having a thickness of 6 μm to form a thermo-sensitive recording medium.

The entire recording medium was heated at 80° C. for 5 minutes to obtain a black background. Next, after the entire recording medium had been cooled down to room temperature, a printing process was carried out by using the above-mentioned reader writer SD500-GPIII so that a blue character was recorded. Then, a hot roller heated to 80° C. was pressed on the half of the recording medium, and this was then cooled down quickly so that only the character was discolored from blue to red; thus, a character of two colors, blue and red, was formed on the black background. Moreover, the entire recording medium was again heated at 80° C. for 1 minute to erase the characters.

### EXAMPLE 6

A black PET film having a thickness of 188 μm was used as a support base, and a:material formed by mixing the compounds represented by the following chemical formulas (C1) and (D1) at a weight ratio of 1:1 was heated to melt at 140° C., and applied thereto with a thickness of 6 μm to form a recording layer. Further, the recording layer was coated with a ultraviolet-ray setting resin having a thickness of 3 μm, and irradiated with ultraviolet rays to form a thermo-sensitive recording medium.

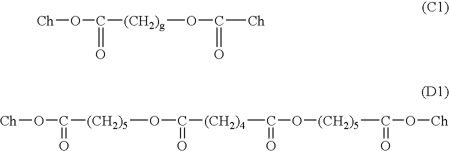

In both of (C1) and (D1), Ch is represented by:

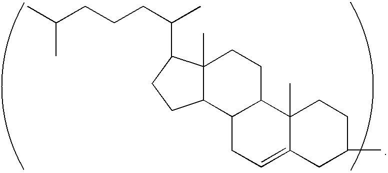

The entire recording medium was heated at 80° C. for 30 minutes to obtain a black background. Next, after the entire recording medium had been cooled down to room temperature, a hot stamp bearing an engraved character that had been heated to 130° C. was pressed thereon, and this was then quickly cooled down; thereby recording a blue-color character on the black background. Next, after having pressed a heated hot roller heated at 80° C. to the half of the area of the recording medium, this was a quickly cooled down so that only the character was changed in color from blue to green; thus, characters of two colors of blue and green were formed on the black background.

### EXAMPLE 7

A black PET film having a thickness of 188 μm was used as a support base, and a material formed by mixing the compounds represented by the following chemical formulas (E1) and (C2) at a weight ratio of 1:1 was dissolved in toluene, and applied thereto with a thickness of 6 μm to form a recording layer. Further, the recording Layer was coated with a transparent PET film having a thickness of 6 μm to provide a thermo-sensitive recording medium with a black background.

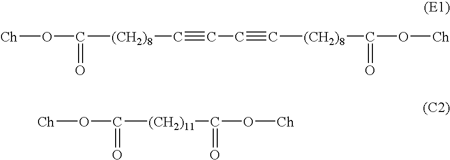

In both of (E1) and (C2), Ch is represented by:

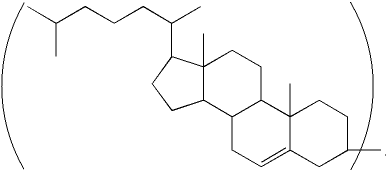

Next, after a hot stamp heated to 90° C., which had a character engraved therein, had been pressed thereon, this was quickly cooled down so that a blue character was recorded on the black background. Next, after a hot roller heated to 40° C. had been pressed on the half of the area of the recording medium, this was quickly cooled down so that only the character was changed in color from blue to green; thus, characters of two colors of blue and green were formed on the black background.

### COMPARATIVE EXAMPLE 1

The same processes as the above-mentioned example 1 were carried out except that a compound represented by the above-mentioned formula (E1) was used as a recording layer so that a thermo-sensitive recording medium was prepared.

The entire recording medium was heated at 80° C. for 15 minutes, and then quickly cooled down; thereby obtaining a black background. Next:, a hot stamp heated to 130° C. with a character engraved therein was pressed thereon, and after having been cooled down to 95° C., this was quickly cooled down so that a green character was recorded on the black background. When a hot roller, heated to80° C., was pressed on the recording medium, the character became colorless and was not confirmed.

### OTHER EXAMPLES

Here, the image forming method in accordance with the present invention is not intended to be limited by the above-mentioned embodiments, and can be modified in various ways within the scope of the gist thereof.

In particular, the mode and structure of the heating means are arbitrarily set, and the heating temperature, temperature rise rate, cooling temperature and cooling rate are properly changed in accordance with the kind and the layer thickness of a liquid crystal to be used in the recording layer.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An image forming method for forming an image on a reversible thermo-sensitive recording medium provided with a recording layer containing liquid crystal that exhibits a cholesteric liquid crystal phase, said image forming method comprising:
a first heating process for heating the liquid crystal in a crystal phase to a first temperature that allows the liquid crystal to exhibit a cholesteric liquid crystal phase or an isotropic phase to form an image; and
a second heating process for heating at least a part of an area of the recording medium containing at least a part of an area where the image has been formed to allow at least a part of the image to discolor or develop a color.

2. An image forming method as claimed in claim 1, wherein the image formed in the first heating process is a visible image.

3. An image forming method as claimed in claim 1, wherein the image formed in the first heating process is a latent image.

4. An image forming method as claimed in claim 1, wherein, in the first heating process, the liquid crystal that has been heated to the first temperature is rapidly cooled down.

5. An image forming method as claimed in claim 4, wherein the liquid crystal that has been rapidly cooled down exhibits a glass phase.

6. An image forming method as claimed in claim 1, wherein the liquid crystal that has been heated to the first temperature exhibits a glass phase.,

7. An image forming method as claimed in claim 1, wherein, in the second heating process, the liquid crystal that has been heated is rapidly cooled.

8. An image forming method as claimed in claim 7, wherein the liquid crystal that has been rapidly cooled exhibits a glass phase.

9. An image forming method as claimed in claim 1, wherein, in the second heating process, the liquid crystal is heated to at most a second temperature that is lower than the first temperature.

10. An image forming method for forming an image on a reversible thermo-sensitive recording medium provided with a recording layer containing liquid crystal that exhibits a cholesteric liquid crystal phase, said image forming method comprising:
a first process for selectively setting portions of the liquid crystal in a crystal phase and a fixed phase and thus forming an image on the thermo-sensible recording medium; and
a second process for discoloring or developing a color of at least a part of the portion(s) set in the fixed phase thus discoloring or developing a color of at least a part of the image.

11. An image forming method as claimed in claim 10, wherein, in the first process, the liquid crystal is heated to a temperature that allows the liquid crystal to exhibit a cholesteric liquid crystal phase or an isotropic phase to form an image, and then rapidly cooled.

12. An image forming method as claimed in claim 10, wherein, in the second process, the liquid crystal is heated, and then rapidly cooled.
